(19) United States
(12) Patent Application Publication
(10) Pub. No.: US 2001/0021915 A1
(43) Pub. Date: Sep. 13, 2001

(54) Compensation driven network based exchange system and method

(75) Inventors: Charles Cohen, London (GB); Neil Forrester, Mildmay Grove (GB)

Correspondence Address: OSTROLENK FABER GERB & SOFFEN, 1180 AVENUE OF THE AMERICAS, NEW YORK, NY, 100368403

(73) Assignee: beenz . com ireland Ltd.

(21) Appl. No.: 09/732,596

(22) Filed: Dec. 8, 2000

Related U.S. Application Data
(63) Continuation-in-part of application No. 09/473,627, filed on Dec. 29, 1999.

(51) Int. Cl. G06F 17/60

(52) U.S. Cl. 705/14

(57) ABSTRACT

A method and system using a communication network, such as the Internet, to compensate at least one user in exchange for work undertaken by the at least one user. The communication network is used to perform work, the work being defined by a content provider in a manner which does not target specific user profiles. Compensation units are offered to the user in exchange for the performed work. The user uses a user terminal to accept the offered compensation units. The accepted compensation units are transferred from a content provider account to a user account, the content provider account corresponding to the content provider offering the compensation units and the user account corresponding to user who completed the work. The user can spend earned compensation units on goods and services offered by are deeming content provider. The compensation units are provided in a closed system. The issuing content provider does not control how, when or where earned compensation units may be spent

### CROSS REFERENCE TO RELATED APPLICATIONS

This application is a continuation-in-part and claims the priority and benefit of U.S. application Ser. No. 09/473,627 filed Dec. 29, 1999 and entitled “COMPENSATION DRIVEN NETWORK BASED EXCHANGE SYSTEM AND METHOD”.

### FIELD OF THE INVENTION

The present invention is related to a system and method which use a communication network to receive compensation and exchange the received proceeds for goods and services. More particularly, the present invention is related to a system and method which allow a user to receive compensation in the form of arbitrarily titled units in exchange for the work of viewing display screens and completing tasks, and which allow the user to subsequently spend the received compensation units on goods and services offered via the same communication network, for example, the Internet and the like.

### DESCRIPTION OF THE RELATED ART

The proliferation of the Internet has many content providers struggling to find ways to disseminate their message, whether that message is an advertisement for products or services in the case of e-commerce, information or entertainment. As such, consumers are typically accosted with new advertising models and techniques designed to capture attention and direct the user to the corresponding Internet web site.

Upon viewing those web sites which are the basis of the advertisements, the user is typically presented with additional advertisements, marketing information or technical information relating to the product or service, and is thereby encouraged to spend additional time visiting that web site. In other words, the user is asked to spend time and engage in a work effort to view the advertiser's products or services. The user is not compensated for time, but rather encouraged to make a purchase, request additional information or even view advertisements for associated goods and services. As such, the user is essentially working for the provider of the goods and services without receiving any compensation.

In an effort to reward users for viewing advertisements or making purchases of particular goods and services, business models and related Internet technologies have been developed which credit a user a certain amount of cash for viewing a targeted advertisement or purchasing a product targeted to the user's interests or purchasing habits. For example, U.S. Pat. No. 5,794,210 issued to Goldhaber et al. is directed to an attention brokerage which provides payment to users for viewing an advertisement or other information. In particular, Goldhaber relies on a central attention brokerage computer to track users' interests and to provide targeted advertisements to the users. In exchange for viewing the advertisement provided by the attention brokerage computer, the user receives cash compensation. In order to target the advertisements, the attention brokerage stores personal profiles of the users and tracks user activity. In return, the users can spend their earned cash.

The model presented by the Goldhaber patent therefore requires a central attention brokerage which acts as a web site intermediary between the user and the targeted advertisements presented thereto. Further, because the attention broker's purpose is to direct targeted advertisements, personal profiles and usage habits of the users are stored in the attention brokerage system.

Another example of a targeted marketing system which rewards users for viewing advertisements and allows users to spend their rewards is a system provided by Mypoints.com, Inc. As with Goldhaber's method, users must register with the system and provide personal information, including personal interests. Points are earned by visiting the Mypoints web site, and viewing targeted advertisements and web sites as directed by the Mypoints.com server. The Mypoints system, therefore, is a targeted advertisement system in which users must access the Mypoints.com server to receive rewards. Users are rewarded for their loyalty to the Mypoints.com web site and for proactively selected targeted advertisements presented by the Mypoints.com web site.

The systems, therefore, are heavily skewed toward the business aspect of the model, because the advertising businesses receive qualified leads in exchange for a few cents. In addition, these systems, much like a frequent flyer system, are loyalty-based. In other words, a user is presented with a series of targeted advertisements, but needs to do additional work beyond visiting the attention brokerage site to receive compensation. Loyalty is rewarded by repeated visits to the attention brokerage by providing access to different types of targeted advertisements through repeated visits to the attention brokerage site.

These models, however, are deficient in at least two respects. First, these models are arranged such that a user cannot receive compensation by going directly to the advertiser's web site. In other words, the user must first complete a task via a centralized computer such as an attention brokerage computer prior to receiving compensation. A user who views the same advertisement in a non-targeted fashion by going directly to the advertiser's web site does not receive compensation.

Second, because the advertisements are targeted, the user must store personal information within the system. Further, the user's usage habits are tracked so that additional targeted advertisements may be presented to the user. However, many users, especially Internet users, are very sensitive to dissemination of their private information, even when the prospect is that of receiving a few pennies for viewing a targeted advertisement.

As such, it is desirable to have a system and method which do not require the user to visit a centralized service in order to view advertisements to receive compensation, and which does not store personal profile information or usage habits as a condition precedent to receiving compensation.

Other web sites and technologies attempt to ease consumers' apprehension for purchasing goods and services over public computer networks such as the Internet. Typically, consumers are apprehensive as to providing personal information, including credit card or debit card numbers to providers of goods and services across the Internet in fear that their accounts will be misused or the account numbers stolen and used for fraudulent purposes. In response, companies such as Flooz.com, Inc. have developed virtual currency, electronic cash systems which allow a user to give gift currency to others. This gift currency is made available to the recipient for purchase of goods and services. The donor, however, must purchase the gift currency from the system provider, in this case, Flooz.com, Inc. The gift currency may not be earned and subsequently spent.

Thus, although the recipient can spend the gift currency, the currency is not actually earned by the donor as compensation for work done on the communication network. Gift currency systems merely provide a convenient way for donors to provide gifts to recipients which are redeemable on the Internet at a multitude of goods and service providers.

Another known technology is cash-based compensation technology, such as the system offered by eCash technologies, Inc. This technology attempts to create a software and hardware infrastructure for digital cash payments in an electronic marketplace via a virtual equivalent to hard currency. These systems are problematic because they require an infrastructure to implement their networks beyond mere attachment to a global computing network, for example, the use of special security hardware, “smartcards” and installation of digital “wallets” by consumers. Further, because these systems are hard currency equivalents, they can be restricted in their scope by banking regulations directed to management of digital currency. In other words, constraints surrounding the use of officially issued currency, such as the U.S. Dollar, inhibit cash-based compensation technology.

As such, there is a need for a compensation system which does not have such restrictions but still retains some of the characteristics of real money, including transparency of value, anonymity, real-time transfer and freedom of choice over where to spend the compensation.

Further, known systems do not provide any incentive for a user to exchange in an extended visit to an advertiser's web site. This is because the known sites rely on their centralized server to direct the targeted user to particularized product or service information. Once the user has viewed this information, there is no incentive to remain at the advertiser's web site.

In addition, known systems do not enable content providers to compensate web site visitors for performing an entire chain of actions in a desired sequence within a predetermined time period, for example, a single web site visit, particularly when the predetermined time period is of some value to the content provider. Using known systems, a user viewing a content provider's web site may merely receive a weak suggestion that there is some value in performing a chain of actions.

It is therefore desirable to have a method and system which allow a user to be compensated in some non-cash form for work the user has completed by viewing information or undertaking tasks as directly provided by the content provider, for example, advertiser, in which the user is not targeted, need not visit a centralized server, and is encouraged to extend the visit to the content provider's web site to provide additional work in exchange for receiving additional compensation. As such, the desired system and method will preserve a user's privacy by neither requiring nor encouraging the dissemination of personal information for the purpose of directing targeted marketing toward the users. Further, there is a need for a system and method which allows compensation to be transferred to a user only after the user has made or performed a number of actions, for example, visiting a content provider's web site a plurality of times.

### SUMMARY OF THE INVENTION

The present invention provides a method using a communication network to compensate at least one user in exchange for work undertaken by the at least one user in which the communication network is used to perform work, the work being defined by a content provider in a manner which does not target specific user profiles, the work further being defined by a plurality of interactions between the user and the content provider. Compensation units are offered to the at least one user in exchange for the performed work, whereby the compensation units are to be provided after a defined number of interactions. The offered compensation units are accepted. Data relating to the number of interactions between the user and content provider is stored. The accepted compensation units are transferred from a content provider account to a user account after the defined number of interactions has been reached, the content provider account corresponding to the content provider offering the compensation units and the user account corresponding to the user who completed the work.

Another aspect of the present invention provides a transaction processor coupled to a communication network, the transaction processor compensating at least one user in exchange for work undertaken by the at least one user, in which the transaction processor has a database and a central processing unit. The database includes an account holder data structure having at least one account holder record and a content provider data structure having at least one content provider record. The central processing unit is coupled to the database and executes the functions of:

evaluating a request from a user terminal to transmit a client to the user terminal;

transmitting the client to the user terminal in accordance with a positive evaluation, the client enabling the user terminal to request compensation in the form of compensation units for work performed by a user of the user terminal, the work further being defined by a plurality of interactions between the user and the content provider;

storing data related to the number of interactions between the user and the content provider;

processing a request received from the user terminal to credit an account holder record corresponding to the user of the user terminal with compensation units in accordance with work performed by the user; and

executing a first transaction process which accesses the database and transfers the compensation units from a content provider record corresponding to the offering content provider to the account holder record corresponding to the user if the defined number of interactions has been reached.

Still another aspect of the present invention provides a system employing a communication network to compensate at least one user in exchange for work undertaken by the at least one user, in which there is at least one user terminal. At least one content provider processor is coupled to the at least one user terminal through a communication network. At least one transaction processor is coupled to the at least one user terminal and the at least one content provider processor through the communication network. The transaction processor receives a request from the at least one user terminal to transmit a client to the at least one user terminal. The transaction processor transmits the client to the at least one user terminal in accordance with a positive evaluation, the client enabling the at least one user terminal to request compensation for work performed by a user of the at least one user terminal, the work further being defined by a plurality of interactions between the user and the content provider. The transaction processor stores data related to the number of interactions between the user and content provider. The transaction processor processes a request received from the user terminal to credit a user account corresponding to the user of the user terminal with compensation in accordance with work performed by the user and transfers the compensation from a content provider account corresponding to the offering content provider to the user account if the defined number of interactions has been reached.

Another aspect of the present invention provides a method for using a communication network to facilitate transactions in which compensation units are earned and spent by at least one user, in which the communication network is used to perform work, the work being defined by a content provider in a manner which does not target specific user profiles, the work further being defined by a plurality of interactions between the user and the content provider. Compensation units are offered to the at least one user in exchange for the performed work, whereby the compensation unites are to be provided after a defined number of interactions. The offered compensation units are accepted. Data relating to the number of interactions between the user and content provider is stored. The accepted compensation units are transferred from a content provider account to a user account after the defined number of interactions has been reached, the content provider account corresponding to the content provider offering the compensation units and the user account corresponding to the user who completed the work. Compensation units are transferred from the user account to a spending content provider account in an amount corresponding to a cost of a purchase made by the user.

As still yet another aspect of the present invention, a transaction processor is provided which is coupled to a communication network, the transaction processor facilitating transactions in which compensation units are earned and spent by at least one user, in which the transaction processor has a database and a central processing unit. The database includes an account holder data structure having at least one account holder record and a content provider data structure having at least one content provider record. The central processing unit is coupled to the database and executes the functions of:

evaluating a request from a user terminal to transmit a client to the user terminal;

transmitting the client to the user terminal in accordance with a positive evaluation, the client enabling the user terminal to request compensation in the form of compensation units for work performed by a user of the user terminal, the work further being defined by a plurality of interactions between the user and the content provider;

storing data related to the number of interactions between the user and the content provider;

processing a request received from the user terminal to credit an account holder record corresponding to the user of the user terminal with compensation units in accordance with work performed by the user;

executing a first transaction process which accesses the database and transfers the compensation units from a content provider record corresponding to the offering content provider to the account holder record corresponding to the user if the defined number of interactions has been reached; and

executing a second transaction process which accesses the database and transfers compensation units in an amount of a purchase made by the user from the corresponding user account holder record to a content provider record corresponding to the content provider from whom the purchase was made.

Still another aspect of the present invention provides a system for facilitating transactions in which compensation units are earned and spent by at least one user in which the system has at least one user terminal. At least one content provider processor is coupled to the at least one user terminal through a communication network. At least one transaction processor is coupled to the at least one user terminal and the at least one content provider processor through the communication network. The at least one transaction processor receives a request from the at least one user terminal to transmit a client to the at least one user terminal. The at least one transaction processor transmits the client to the at least one user terminal in accordance with a positive evaluation, the client enabling the at least one user terminal to request compensation for work performed by a user of the at least one user terminal, the work further being defined by a plurality of interactions between the user and the content provider. The transaction processor stores data related to the number of interactions between the user and the content provider. The transaction processor processes a request received from the user terminal to credit a user account corresponding to the user of the user terminal with compensation units in accordance with work performed by the user. The transaction processor transfers the compensation units from a content provider account corresponding to the offering content provider to the user account if the defined number of interactions has been reached. The transaction processor also transfers compensation units in an amount of a purchase made by the user from the corresponding user account to a content provider account from whom the purchase was made.

As still another aspect of the present invention, a computer readable storage medium storing a computer executable program code is provided, which when run, executes a method for compensating at least one user in exchange for work undertaken by the at least one user, in which a request is received from the at least one user terminal to transmit a client to the at least one user terminal. The client is transmitted to the at least one user terminal in accordance with a positive evaluation, the client enabling the at least one user terminal to request compensation for work performed by a user of the at least one user terminal, the work further being defined by a plurality of interactions between the user and the content provider. The transaction processor stores data related to the number of interactions between the user and the content provider. A request received from the user terminal is processed to credit a user account corresponding to the user of the user terminal with compensation in accordance with work performed by the user. The compensation units from a content provider account corresponding to the offering content provider are transferred to the user account if the defined number of interactions has been reached.

Other features and advantages of the present invention will become apparent from the following description of the invention which refers to the accompanying drawings.

### BRIEF DESCRIPTION OF THE DRAWINGS

For the purpose of illustrating the invention, there are shown in the drawings several forms which are presently preferred, it being understood, however, that the invention is not limited to the precise arrangements and instrumentalities shown.

FIG. 1 is a diagram of an example of a hardware arrangement of a compensation system of the present invention;

FIG. 2 is a block diagram of the functional elements of a transaction processor of the present invention;

FIG. 3 is an iconic view illustrating the earning process of the present invention;

FIG. 4 is an iconic view illustrating the spending process of the present invention;

FIG. 5 is a diagram of example database data structure arrangements of the present invention;

FIG. 6 is a flow chart detailing user and offer validation during the compensation earning process of the present invention;

FIG. 7 is an example of a web site display page of the present invention;

FIG. 8 is a flow chart detailing a process which is executed once the compensation client has been transmitted to a user terminal during the compensation unit earning process of the present invention;

FIG. 9 is an example user display screen of an electronic mail address authentication request according to the present invention illustrating one possible authentication method;

FIG. 10 is an example of an address recognition failure box displayed on a user terminal in accordance with the present invention;

FIG. 11 is a flow chart of content provider trail establishment and administration processes in accordance with the present invention;

FIG. 12 is a flow chart of the trail portion creation and editing processes of the present invention;

FIG. 13 is an example of a redemption display screen presented on the display of a user terminal in accordance with the present invention;

FIG. 14 is an example of a statement display screen presented on the display of a user terminal in accordance with the present invention; and

FIG. 15 is a detailed view of a transaction description block presented on the display of a user terminal in accordance with the present invention.

### DETAILED DESCRIPTION OF EMBODIMENTS OF THE INVENTION

Initially, it is noted that the terms “goods,” “services” and “products” are used interchangeably herein. As such, the use of one term herein is not intended to limit the discussion to the object of that term.

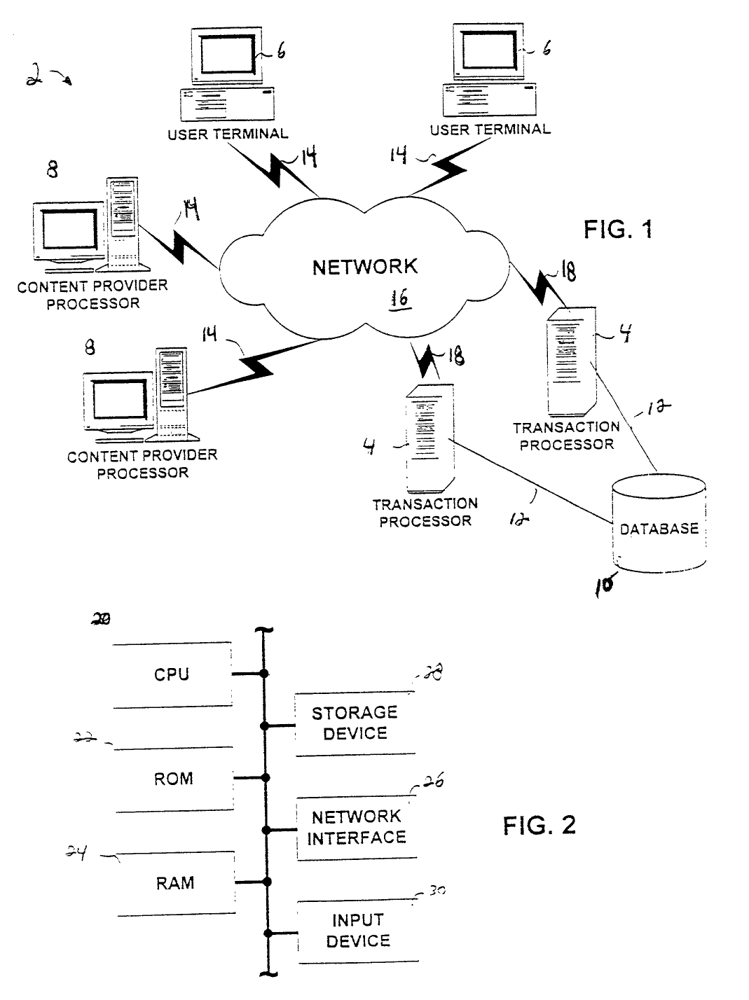

Referring now to the drawings in which like reference numerals refer to like elements, there is shown in FIG. 1 a diagram of an example of compensation system 2 of the present invention. Compensation system 2 is comprised of one or more transaction processors 4, one or more user terminals 6 and one or more content provider processors 8. Content provider users, for example, those administering content provider accounts, can do so using content provider processors 8 or a separate terminal (not shown). Transaction processors 4 are also arranged to communicate with database 10. Database 10 can be integrated within the physical housing of one or more of transaction processors 4, or can be a separate unit. If separate, database 10 can communicate with transaction processor 4 via connection 12 using any known communication method, including a direct serial or parallel interface or via a local or wide area network.

User terminals 6 and content provider processors 8 communicate over data connections 14 to transaction processors 4 through communication network 16 via transaction processor links 18. Communication network 16 can be any communication network but is preferably the Internet or some other global computer network. Data connections 14 and transaction processor links 18 can be any known arrangement for accessing communication network 16, such as dial-up serial line interface protocol/point-to-point protocol (SLIP/PPP), integrated services digital network (ISDN), dedicated leased-line servers, broadband (cable) access, frame relay, digital subscriber line (DSL), asynchronous transfer mode (ATM), or other access technique.

User terminals 6 have the ability to send and receive data across communication network 16 and the ability to display the received data on a display device using appropriate communication software such as an Internet web browser. By way of example, terminals 6 may be personal computers such as INTEL Pentium-based computers or APPLE McIntosh computers, but are not limited to such computers. Other terminals which can communicate over a global computer network, such as palm top computers, personal digital assistance (PDAs), wireless devices and mass marketed Internet access devices, i.e., WebTV, can be used.

According to the present invention, user terminals 6 access content provider processors 8 and transaction processors 4 for the purpose of performing work at content provider processor 8, receiving compensation therefor, and spending the compensation at the same or a different content provider processor 8. Transaction processors 4 facilitate the administration of allocating compensation in the form of compensation units and tracking the spending of compensation units for products. As discussed below in detail, transaction processors 4 also allow a compensating content provider to arrange for a trail in which the various steps of the trail are tracked by transaction processor 4, allocating compensation to a user of user terminal 6 as that user progresses through the trail.

Compensation system software which controls the compensation allocation, spending and account maintenance and other system functions resides primarily on one or more transaction processors 4. Transaction processors 4 typically communicate with network 16 across a permanent, i.e., unswitched, transaction processor link 18. Permanent, i.e., non-dial-up, connectivity ensures that access for transaction processors 4 is always available to user terminals 6 and content provider processors 8.

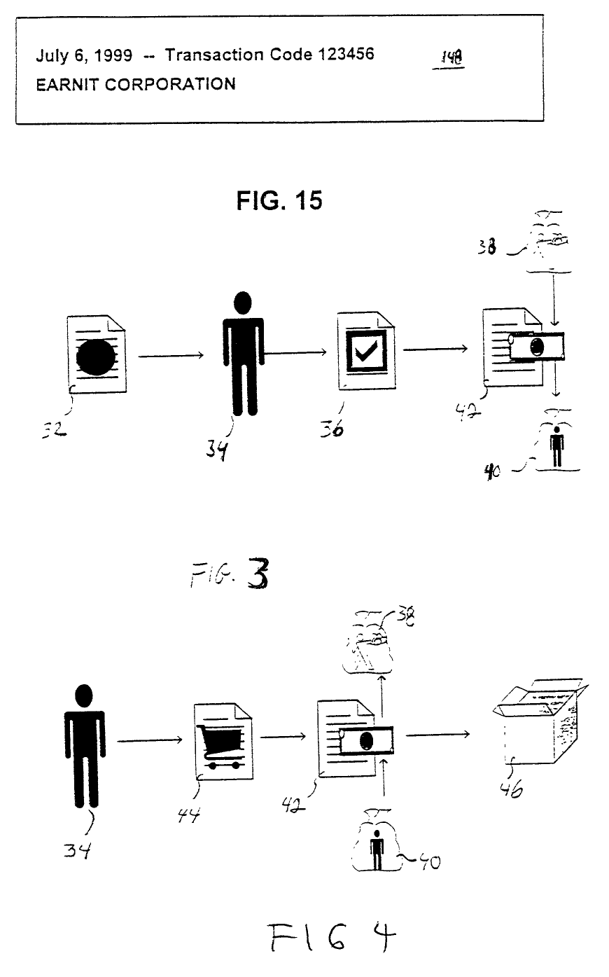

As shown in FIG. 2, the functional elements of each transaction processor 4 preferably include a central processing unit (CPU) 20 used to execute software code in order to control the operation of the transaction processor, read-only memory (ROM) 22, random access memory (RAM) 24, at least one network interface 26 to transmit and receive data to and from other computing devices, such as user terminals 6 and content provider processors 8 across communication network 16, a storage device 28 such as a floppy disk drive, hard disk drive, tape drive, CD-ROM and the like for storing program code, databases and application data, and one or input devices 30 such as a keyboard and mouse.

The various components of transaction processors 4 need not be physically contained within the same chassis or even located at a single location. For example, as explained above with respect to database 10 (which can reside on storage device 28), storage device 28 may be located at a site which is remote from the remaining elements of transaction processor 4, and may even be connected to CPU 20 across communication network 16 via network interface 26.

The nature of the invention is such that one of ordinary skill in the art of writing computer executable code (software) will be able to implement the described functions using one or a combination of popular computing programming languages such as “C++,” Visual Basic, JAVA, HTML (hypertext markup language) or active-X controls and/or a web application development environment.

One of the functions performed by transaction processors 4 is that of operating as a web site for the establishment and administration of user and content provider compensation unit accounts. Similarly, content provider processors 8 act as web sites. A web site typically communicates with web browsers using the hypertext transfer protocol (HTTP) to send and receive data, including HTML web page data and executable JAVA applets. Of course, any known data transfer protocol and web site definition language can be used to implement compensation system 2.

As used herein, references to displaying data on a terminal refer to the process of communicating data to the terminal across communication network 16, and processing the data such that the data can be viewed on the terminal screen using an Internet browser or the like. The display screen on user terminal 6, and the content provider user devices, displays data which allows a user to “move” from web site to web site, and even to display a composite image comprised of data gathered from multiple web sites. As such, each user's experience with compensation system 2 will be based on the order with which they progress through, i.e., navigate, the various links. In other words, because the system is not completely hierarchical in its arrangement of display screens, users can proceed from site to site and area to area within each site without the need to “backtrack” through a series of display screens. For that reason, unless stated otherwise, the following discussion is not intended or represent any sequential steps, but rather a description of the components and operation of a compensation system.

Although the present invention is described by way of examples herein in terms of a web-based system using web browsers and processors (content provider processor 8 and transaction processor 4), compensation system 2 is not limited to that particular configuration. It is contemplated that compensation system 2 can be arranged such that user terminals 6 can communication with, and display data received from, content provider processor 8 and transaction processor 4 and content provider processor 8 can also communicate with transaction processor 4 using any known communication and display method, for example, using a non-Internet browser WINDOWS viewer coupled with a local area network protocol such as the internetwork packet exchange (IPX) protocol or a custom developed browser in a mobile cellular telephone coupled with a wide are networking protocol such as the wireless application protocol (WAP).

Content provider processors 8 and user terminals 6 maintain the same general configuration of functional elements as transaction processor 4, with those elements sized for the expected usage and required performance of the devices. For example, user terminals 6 may have a CPU 20 which is of lesser capacity than that in transaction processor 4 and content provider processor 8 but may be additionally equipped with a sophisticated display or input device beyond those needed to support the operation of transaction processor 4 or content provider processor 8. Similarly, transaction processor 4 and content provider processor 8 may have storage device capabilities far in excess of that needed by user terminal 6. In addition, although data connection links 14 can be of the same level of capability as those links coupled to user terminals 6, content provider processors 8 may be coupled to network 16 through dedicated, high speed links such as those described above with respect to transaction processor links 18.

It should be noted that the arrangement of transaction processors 4 and database 10 allow the present invention to rapidly scale to accommodate large numbers of users and user terminals 6, and support large volumes of content providers, i.e., web businesses. For example, it has been advantageously found that the system can support in excess of one million transactions per day (in which a transaction takes several seconds to complete all of its stages) via two INTEL-based processors using the LINUX operating system coupled to a database 10 comprised of two SUN ES4500 servers along with a total of four SUN A5000 and A5100 RAID arrays.

According to this arrangement, transaction processors 4 provide the actual web interface to user terminals 6 and content provider processors 8, while database maintains user and content provider data and executes those processes necessary to support compensation unit accounting, distribution and spending, i.e., redemption. Of course, it is contemplated that transaction processors 4 themselves can execute these compensation unit tracking functions such that they need not be distributed to a separate processor such as might be used to operate database 10. As such, discussion relating to functions performed by transaction processor 4 should be understood to include that these functions can be distributed to database 10 for processing, presuming, of course, that database 10 is equipped with a CPU, memory, etc.

The overall method of the present invention is explained with reference to FIGS. 3 and 4 in which FIG. 3 is an iconic view illustrating the earning process and FIG. 4 is an iconic view illustrating the spending process. A web site display page 32 has been visited by user 34 and is presented to user 4 on user terminal 6. Preferably, user terminal 6 accesses web site display page 32 which is located on content provider processor 8 via network 16. In exchange for having viewed web site display page 32, user 34 is offered the opportunity to receive compensation 36.

As is discussed below in detail, the opportunity to receive compensation 36 is presented to the user as part of web site display page 32 or as a confirmation pop up or “silently”. If user 34 elects to receive the compensation through an appropriate method of indication, for example, “clicking” on an acceptance icon, compensation units are transferred from content provider account 38 to user account 40 through compensation transfer process 42. Preferably, content provider account 38 and user account 40 are maintained in database 10. Compensation transfer process 42 is carried out by transaction processor 4 by crediting user account 40 and debiting content provider account 38 in the amount of compensation units offered to user 34.

Preferably, content provider account 38 is credited with compensation units through the purchase of these compensation units from the owner of transaction processor 4. Transaction processor 4 monitors the account levels of content provider account 38 and can alert the content provider, preferably by sending a message to content provider processor 8 or an associated content provider contact electronic mail address that the content provider account 38 is running low. The content provider can replenish content provider account 38 as necessary through payment to the provider of transaction processor 4.

As user 34 visits web sites and works for content providers, user account 40 accumulates a compensation unit balance. User 34 can spend those earned compensation units with content providers who offer goods and services in exchange for compensation units. The spending model according to the present invention is explained with reference to FIG. 4. As shown in FIG. 4, user 34 spends earned compensation units by shopping for goods or services, for example. Methods for shopping on computer networks are widely known. Once the items to be purchased have been identified, the transaction is effected by compensation transfer process 42 which debits user account 40 and credits content provider account 38. It should again be noted that the content provider account 38 receiving the compensation unit credits during the user's purchasing activity is not limited to the same content provider account 38 which provided the compensation units to user 34 during the earning process.

Compensation transfer process 42 ensures that user account 40 has enough compensation units available to complete the transaction. Once compensation unit transfer is complete, product 46 is made available to user 34.

It should be noted that system 2 is a closed system with respect to compensation units. In other words, compensation units do not circulate, cannot be traded between users and preferably cannot be redeemed by users directly with the provider of transaction processor 4.

Further, the issuing content provider has no control over where the compensation units are spent. In other words, unlike loyalty-based award programs, the content provider issuing the compensation units can not dictate when the issued compensation units must be spent, where they must be spent or how they must be spent. A user who earns compensation units is free to spend the earnings with any content provider who accepts the compensation units, even where the accepting content provider is a competitor of the content provider who issued the compensation units to the user.

For example, user 34 may earn fifty compensation units after having viewed a particular content provider's web site display page 32, These compensation units are credited to user account 40 without restriction as to where they may be spent. As such, user 34 may spend his or her earnings with a direct competitor who is offering a better deal on goods or services sought by user 34. This stimulates competition both for content providers seeking to compensate users and those who accept compensation units in exchange for goods and services by facilitating a market-based economy driven by users who seek the greatest amount of compensation for their work and who seek the best value when spending their earnings.

It is contemplated that the operator of transaction processor 4 and database 10 can generate revenue to support their activities by charging issuing content providers one price for compensation units, and redeeming compensation unit account balances with content providers who offer goods and services in exchange for content units at a redemption price lower than that charged to issuing content providers.

According to a preferred embodiment of the invention, users are only awarded compensation units after they have completed a prescribed number of actions, defined as interactions herein. Content providers desire that users return to their website a plurality of times, perform a substantial amount of work at their website (as defined by a defined number of incremental time periods) or perform a substantial number of defined tasks at their website or even off line, before compensation is transferred to the user's account. In order to implement such a process, it is necessary that data be stored relating to the number of interactions between the user and content provider or that the user accumulate “credits” and that compensation units be awarded only after a defined number of interactions, i.e., N interactions, or after a defined number of credits have been accumulated have occurred. It is only after the Nth interaction has occurred that compensation units are issued by the content providers to the user who has achieved the prescribed number of interactions.

In order to accomplish this, each web page of the content provider is assigned a code. When the user has interacted with the web page, a code is recorded in a data base as the interaction takes place. Preferably, in order to ensure that fraudulent means are not used to interact with the content provider's website, for example, via certain computer programs which are designed to interact with the content provider website autonomously without a human user actually spending time at the website, it is preferable that a minimum elapsed time between interactions must occur. Further, it may also be desirable that there be a certain maximum time period between a prescribed number of interactions, for example, the first action to the last action must occur within a certain prescribed time interval. If that time interval is exceeded, and the prescribed number of interactions have not occurred, compensation units are not awarded. It is not necessary that the two interactions that must occur in the maximum time period be consecutive interactions. They may be consecutive interactions or they may be interactions framing a number of interactions in between the two interactions. It is only necessary that the two framing interactions occur within the defined maximum time period.

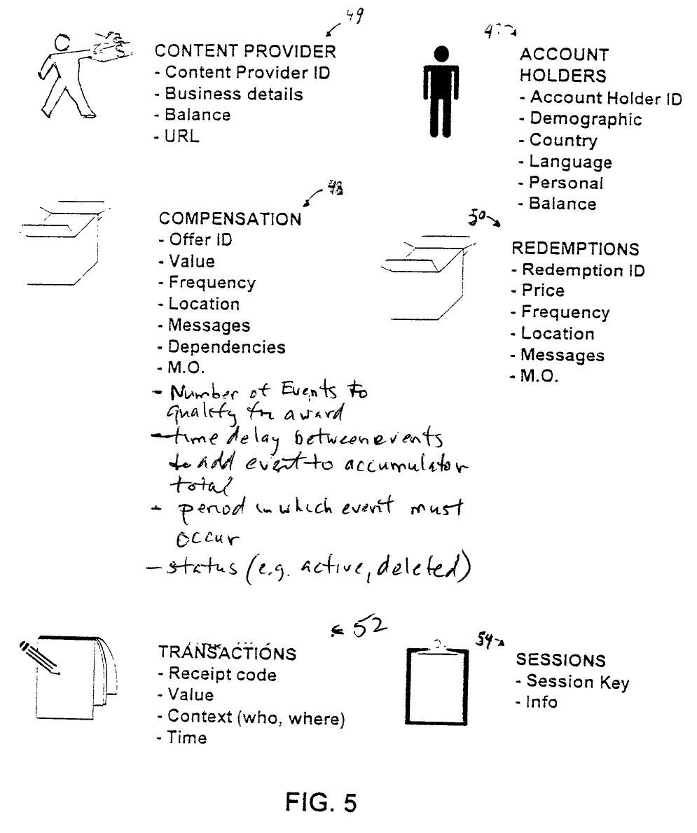

Before explaining the earning and spending processes in detail, it is necessary to understand the arrangement of database 10, explained with reference to FIG. 5. Database 10 is preferably comprised of six main data structures, including account holders data structure 47, compensation data structure 48, content provider data structure 49, redemptions data structure 50, transactions data structure 52 and sessions data structure 54.

Account holders data structure 47 maintains data records relating to users 34, optionally including fields for account holder ID, demographic, country, language, personal and balance information. The account holder ID (user ID) is unique to each account holder. Demographic information includes but is not limited to the user's age, gender, income level, etc. Account holder's country information is used to allow a content provider to offer compensation to users from certain countries, preferably their own country. Language identification allows a user's interaction with transaction processor 4 to be conducted in their native language. Personal information includes the user's name, electronic mail address, user identification and password for access to transaction processor 4 and other information which may be deemed necessary. Balance information indicates the quantity of compensation units available for the user 34 associated with the particular account.

It should be noted that, although account holders data structure 47 provides for the storage of demographic and personal information, this information is not used to target advertisements to user 34 but rather to properly identify user 34 within the context of system 2, and to provide information to merchants 50 regarding the demographic composition of users who have received compensation therefrom.

Compensation data structure 48 contains records relating to particular ways users may earn compensation units. Offers are made available by content providers. Compensation data structure 48 records are comprised of offer ID, offer value information, frequency information, number of events to qualify for an award, location information, messages, dependencies, mode of operation, time limits (time delay between events to add events to accumulator total, period in which events must occur) information fields, and status (e.g. active, deleted).

Preferably, at the client machine or transaction server, a record is held of the user, offer and current accumulator total.

The offer ID represents a unique identifier for the compensation being offered to a user as a result of the user's engagement in the activity associated with the offer. Value information refers to the quantity of compensation units available to a user who accepts the offer. Frequency refers to how often a user may receive compensation for a particular offer. The number of events to qualify for an award is, as it states, the number of events that the user must accumulate to obtain a reward. An accumulator record is maintained on the client machine or transaction server of the current status of this number. Once the number has been reached for a particular user and offer, the award is triggered. Location refers to the particular URL, i.e., web page, from which the content provider will make the offer. As is discussed below in detail, an offer is not a valid offer if the page which the user was viewing at the time the offer is accepted does not match the location information field in compensation data structure 48.

Messages refer to text which will be presented on the user's display when the offer is made available to the user and/or after compensation has been given to a user. Dependencies information is used in conjunction with trails and refers to the URL(s) that a user must have visited prior to being offered compensation.

Mode of operation in compensation data structure 48 refers to the way that an offer is instantiated in the display screen in which it is placed. Examples include, as a button, as a pop-up window upon page load or as a pop-up window appearing after a predetermined delay after the corresponding display screen is loaded on user terminal 6. Alternatively, this can be performed “silently”. Mode of operation is described in further detail below.

It is also contemplated that compensation data structure 48 can include a duration field which defines how long an offer will be made available.

Further, as described above, the compensation data structure includes the number of actions required for an award. An accumulator is preferably maintained on the client machine or transaction server that stores the number of accumulated events or credits attributed to a user. Once the user has obtained a predefined number of events or credits (generally determined by a number of interactions) for a particular offer, compensation units can be transferred to the user account. The status of the user and offer is also preferably maintained at the client machine or at transaction server.

Additionally, compensation data structure 48 includes, if desired, the period in which the events must occur data defining the maximum time period in which the required interactions must occur. Also, the structure includes data defining a minimum time delay between events before and events added to the accumulator total. This is advantageous to discourage computer programmed applications from generating events automatically without the actual presence of a human being.

Content provider data structure 49 is comprised of records having content provider ID, business detail information, balance information and uniform resource locator (URL) information fields. The content provider ID is a unique identification number assigned by system 2 for each content provider. Business detail information identifies the nature of the content provider's business, for example, electronics, entertainment, clothing, network design services, etc. This allows the provider of transaction processor 4 to categorize content providers for easier identification by users who have compensation units they wish to spend, or to identify content providers whom they seek to locate.

Content providers balance information stores records which include the current compensation unit balance available to dispense, in the case of a content provider offering compensation units in exchange for work, or the balance of compensation units received for content providers who exchange goods and services for compensation units.

The URL identifies the home page of the content provider, for example, the location that a user should be pointed to if they request information about the content provider.

Redemptions data structure 50 stores records relating to goods and services for which compensation units may be exchanged, i.e., seller oriented transactions. Redemptions data structure records include redemption ID, price information, frequency information, location information, messages information and mode of operation fields.

The redemption ID is a unique identification number assigned by system 2 for each redemption offer. Price identifies the cost, in compensation units, of the good or service for which redemption is sought. Frequency refers to how often a user may receive compensation for a particular offer. Location refers to the URL associated with the particular good or service for which redemption is sought. For example, a user shopping for a good or service selects that good or service from a selling content provider. The location URL allows transaction processor 4 to properly determine the price, frequency and messages parameters by searching for the URL associated with the selected product.

Messages information refers to messages to be presented to the user during and after the redemption process. For example, a message appearing in a separate pop-up window on the user's display.

Mode of operation in redemptions data structure 50 refers to the way that an offer is instantiated in the display screen in which it is placed. Examples include, as a button, as a pop-up window upon page load or as a pop-up window appearing after a predetermined delay after the corresponding display screen is loaded on user terminal 6. Mode of operation is described in further detail below.

It is also contemplated that redemptions data structure 50 can include a duration field which defines how long an offer will be made available. The duration field is useful when the redemption transaction is used to purchase access to goods and services which will only be available for a fixed amount of time. For example, purchasing access to information placed on a web site for a specific period of time, such as a news article paid for once a day.

Transactions data structure 52 stores records relating to the acceptance of offers and redemption of compensation units associated with compensation transfer process 42. Transactions data structure 52 records are comprised of receipt code information, value information, context information and time information fields. Receipt code information refers to a unique code assigned to each transaction and is transmitted to both parties to the transaction, i.e., the user and the content provider, as a record that the transaction took place. The receipt code field is useful for auditing and dispute resolution purposes.

The value information refers to the compensation unit associated with the transaction, context identifies the user 34 and content provider engaged in the transaction, along with the URL of the page associated with the particular transaction. Time refers to the date and time that the transaction occurred. Receipt code includes an identifier as to whether the transaction was a compensation transaction providing compensation units to a user, or whether it was a redemption transaction.

Sessions data structure 54 contains records relating to particular transaction sessions in progress. For example, as is explained below in detail, a session is created when a user enters a content provider web site and indicates acceptance of a compensation offer. The establishment of a session opened for some period of time allows transaction processor 4 and database 10 to react quickly to the user and content provider's interaction with transaction processor 4 and database 10 and allows user terminal 6 and content provider processor 8 to connect to transaction processor 4 across network 16 using a limited set of TCP/IP ports. In this manner, large scale operation can be supported on transaction processor 4 and database 10 because the data paths between user terminal 6, content provider processor 8 and transaction processor 4 occur over a limited number of TCP/IP ports, thereby obviating the need for transaction processor 4 to initiate, support and tear down TCP/IP ports. Instead, users and content providers communicate with transaction processor 4 over these limited number of ports, identified by sessions within transaction processor 4.

As such, sessions data structure 54 records are comprised of a session key and information relating to that session key. In other words, the session allows a conversation to occur between two parties, for example, user terminal 6 and transaction processor 4, which have no established protocol connection created. The actual transaction process is tracked by appending session stage data to the session key. This allows transaction processor 4 to determine the particular point in a transaction in which a user is engaging, for example, accepting an offer for compensation, verifying a valid URL offer location, verifying particular compensation unit credit availability during a purchase process, etc. In other words, each individual user activity can be tracked by appending a session identifier to the session key.

The information relating to the session key includes the content provider ID, the account holder ID, the offer or redemption ID, transaction receipt code and a type field which identified the type of transaction taking place, for example, earning or spending, the stage at which the transaction is at and the date and time of the last completed stage.

Receiving compensation for having worked at a web site entails two major aspects. First, the user and offer must be verified to ensure that the user is not fraudulently attempting to receive undeserved compensation. Upon completion of this process, a client, for example, a JAVA client is issued to the user's web browser, i.e., display, so that the user can continue the compensation receipt process. The second major aspect involves the actual crediting of compensation units to user account 40 through session interaction with transaction processor 4. Each of these main aspects will now be described.

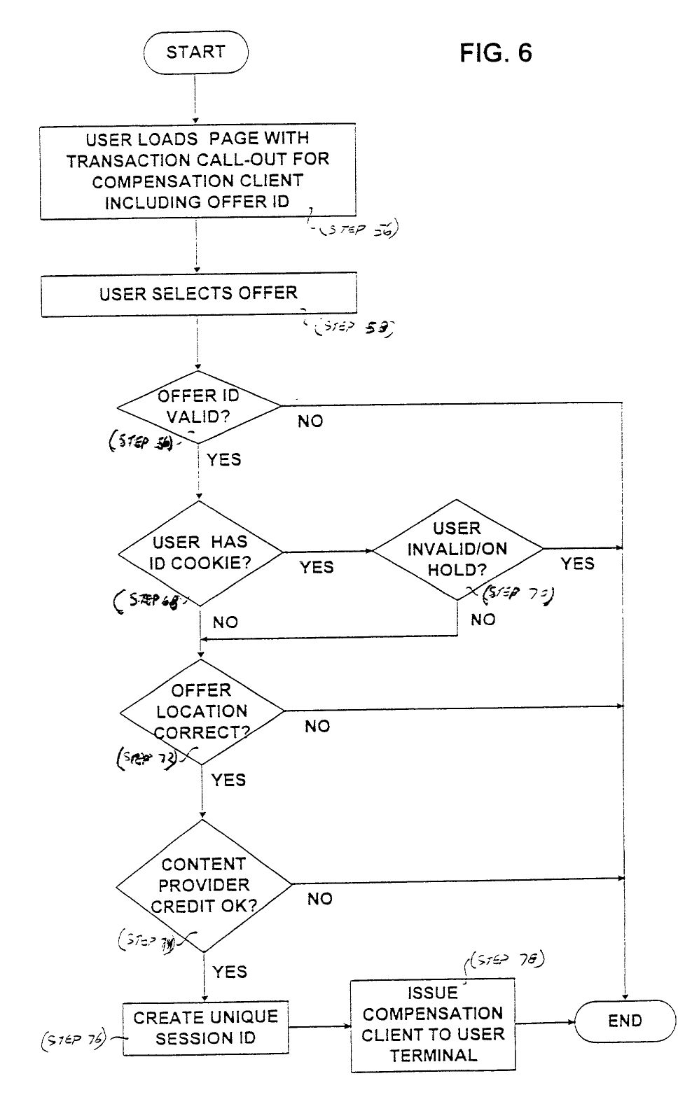

FIG. 6 is a flow chart detailing the first main aspect of compensation receipt, that of validating the user and offer. As discussed above, a user interacts with the communication network, for example, the Internet, by viewing web pages presented on their web browser or other graphical user interface display. At some point, a user has viewed a page or engaged in an activity for which the user is entitled to compensation. This is indicated by a user loading a page into their web browser with a transaction call-out for the compensation client application in which the offer ID is embedded therein (step 56). Loaded page 32 can be any web page. Preferably, this web page is designed and provided by the content provider and provided on content provider processor 8. Transaction call-out for the compensation client refers to applicable tags or programmatic code which, when selected, cause user terminal 6 to attempt to load the compensation client from transaction processor 4. Although a code may be provided “on page” by the content provider, this is not necessary. The accumulator technology need not be limited to “on page” code. The system could be configured to operate a multiple event driven reward system from some server side code.

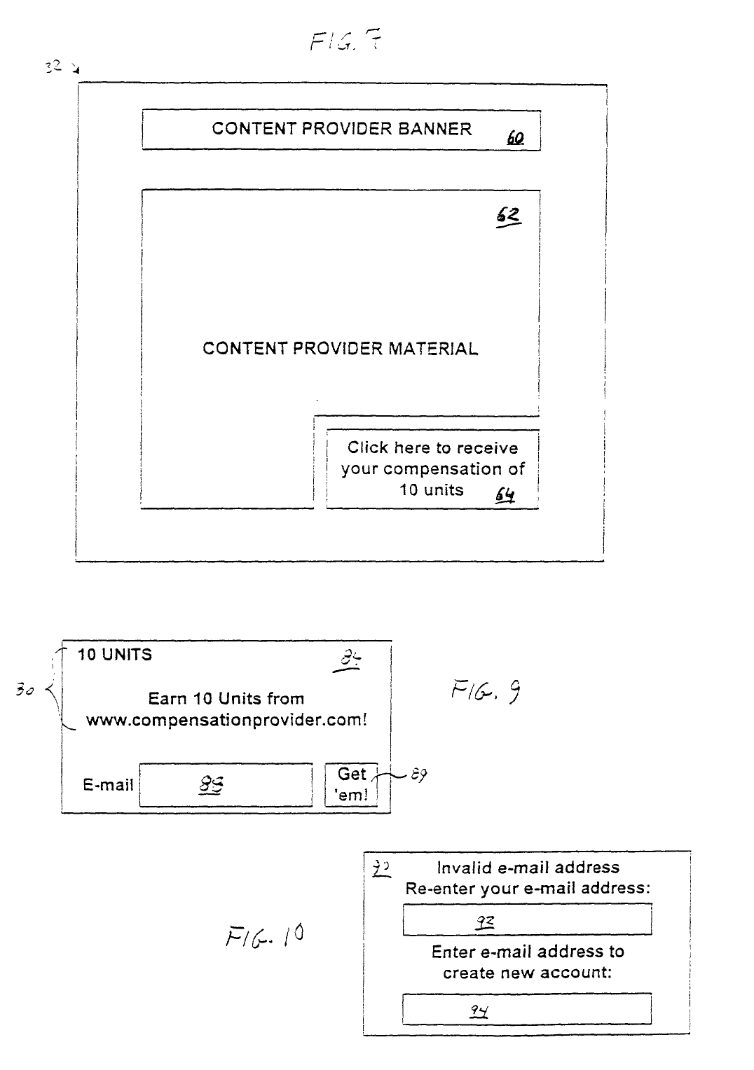

The compensation client can be, but is not limited to, a JAVA applet, active-X controls, an application embedded in a Global System For Mobile Communications (GSM) subscriber identity module (SIM) card or “smartcard”, a read only memory (ROM) device within the client machine or any other contemporary application which allows a user to establish a session with transaction processor 4. A user, whether registered with transaction processor 4 or not, i.e., whether they have an account or not, opts to receive the compensation by selecting the appropriate link on web site display page 32 (step 58). Alternatively, the user may instead be notified that he has received compensation, in effect, implicitly accepting an offer. An example of web site display page 32 is shown in FIG. 7 and is explained as follows. Web site display page 32 is preferably comprised of content provider banner 60, content provider material 62 and compensation information area 64, Of course, web site display page 32 can be arranged in any manner needed to meet the business objectives of the content provider. For example, content provider banner 60 may provide the name of the content provider or an advertisement, while content provider materials 62 may present information about a particular product, links to other web sites, and the like. Regardless of the arrangement of content on web site display 32, compensation information area 64 preferably appears somewhere within the display page, although it may not. As discussed above, a user can elect to receive the compensation by selecting compensation information area 64 or be informed that the compensation has occurred. It should be noted that, although FIG. 7 shows compensation being offered in the amount of ten units, any amount of compensation can be offered depending on the desire of the content provider.

Referring again to the flow chart in FIG. 6, once a user has selected compensation information area 64, user terminal 6 transmits a session request message to transaction processor 4 via communication network 16 in which the request contains the offer ID for the offer along with data corresponding to the URL of the display screen the user was viewing when they selected compensation information area 64. Transaction processor 4 preferably makes five main determinations prior to issuing the compensation client to the browser on user terminal 6. These determinations are as follows:

whether requested offer ID is valid (step 56);

whether the user has an ID cookie placed on it by content provider processor 8 (step 68);

whether the user ID is invalid or on hold (step 70);

whether the web site URL from which the user selected compensation information area 64 matches with the URL in compensation data structure 48 (step 72); and

whether content provider account 38 associated with content provider processor 8 has a balance sufficient to issue compensation units in the amount of the offer (step 74).

As used herein, the term “cookie” refers to the process by which a server connection, for example, content provider processor 8 and transaction processor 4, can store information on, and retrieve information from, the client, for example, user terminal 6. Cookies, therefore, extend the capabilities of web-based applications by allowing a server to retrieve information stored on the client at a later time. Cookies, for example, can record user preferences, user IDs and passwords, and store information such as visited links or other security codes. Cookies are typically set or read by common gateway interface-bin (CGI-bin) scripts and JAVA scripts.

An example of a user account being on hold is one in which the user has already taken the offer and must wait some predetermined time, as indicated by the appropriate record in compensation data structure 48, before additional compensation will be granted. This identification is possible without the need to inquire as to the user's electronic mail address (or user ID) because the user terminal has an ID cookie set therein.

If the offer ID is invalid, the location incorrect or the content provider account balance insufficient to accommodate the user's compensation request, the compensation browser is not issued to the client and processing ends. Similarly, if the user has an ID cookie on user terminal 6 and the user is invalid, i.e., not recognized by transaction processor 4 or is on hold, the compensation client is not issued to the browser. In any of these cases, transaction processor 4 preferably transmits a message to user terminal 6 which is displayed on the display screen to indicate the reason for failure. Of course, no message need be sent at all.

In the case where the offer ID is validated by transaction processor 4, i.e., a record in compensation data structure 48 is found which corresponds to the offer ID, the user either has no ID cookie set or is otherwise validated in step 70, the offer location in the corresponding compensation data structure record matches the originating web site display page 32 URL and the content provider has a sufficient compensation unit credit balance in content provider account 38, transaction processor 4 creates a unique session ID, creates a record in sessions data structure 54 (step 76) and transmits the compensation client to user terminal 6 (step 78). At this point, a user has received the programmatic code necessary to continue the compensation process and have compensation units credited to their account.

It should be noted that, although the present invention is preferably implemented to include the transmission of a compensation client to user terminal 6, the invention is not limited to such. It is contemplated that the present invention can be implemented using any web browser or graphical user interface and data transmission technique in which user terminal 6 receives display screen data, for example, HTML code, and transmits responsive data, for example, a completed form, back to transaction processor 4.

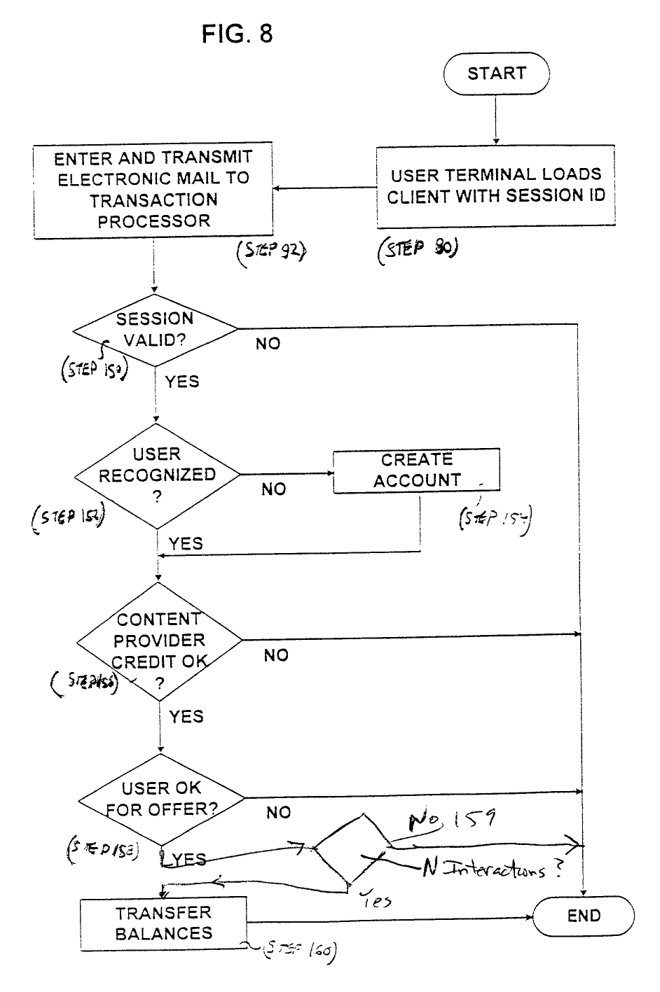

FIG. 8 is a flow chart of the second portion of the compensation unit earning process of the present invention, namely, a process which is executed once the compensation client has been transmitted to user terminal 6.

Upon receiving the compensation client, user terminal 6 loads the client into its memory along with the unique session ID generated by transaction processor 4 (step 80). The compensation client contains programmatic code which causes user terminal 6 to display a request that the user enter their electronic mail address (step 82). The session ID is appended with state information (forming a session key), for example, a code indicating initial user ID validation, and transmitted to transaction processor 4 along with the user's electronic mail address (user ID).

The present invention is preferably arranged such that the user account is identified by their electronic mail address. However, it is contemplated that any means of identification, including a uniquely assigned or requested account identification character string (user ID) can be used. As such, references made to entry of an electronic mail address for the purpose of user identification and authentication are presumed to include any means of identification. In addition, a user can be pre-authenticated by storing their identity in advance at a location which can be accessed by the client software or provider of transaction processor 4, for example in a “smartcard” placed in the client device, a file stored on the client computer and the like.

FIG. 9 shows an example of the electronic mail address authentication request presented on the display of user terminal 6 as part of step 82. FIG. 9 shows electronic mail address request box 84. Electronic mail address request box 84 is comprised of textual message 86, address input area 88, and entry box 89. The user selects entry box 89 once they have entered their address. This causes user terminal 6 to transmit the user's address, entered in address input area 88, to transaction processor 4. Although FIG. 9 shows that ten compensation units being offered, this is merely an example, it being understood that any compensation amount can be offered.

Upon receipt of the electronic mail and session key data, transaction processor 4 conducts an additional set of validation operations before any compensation units are transferred from content provider account 38 to user account 40.

In particular, transaction processor 4 validates the session (step 150) by checking the session key transmitted to terminal 4 against the key stored in sessions data structure 54. If the session is invalid, the session terminates and the user is provided either with an error message or receives no subsequent response from transaction processor 4.

Transaction processor 4 also verifies that the user has an established user account by checking the user's received electronic mail address against the list of accounts in user account holder data structure 40 (step 152). If the user is not recognized, transaction processor 4 causes user terminal 6 to inquire as to whether the user would like to create an account. Assuming the user would like to create an account, transaction processor 4 transmits account creation displays and data to user terminal 6, the process of which is described in detail below (step 154). It should be noted that the account creation request can be combined with an opportunity for the user to reenter their electronic mail address in the event that their initial entry was in error.

Once an account has been created or the user recognized, the compensation unit balance in the respective content provider account 38 is again checked to ensure that there is a balance sufficient to cover the compensation unit debit and transferred to user account 40 (step 156). Although this step appears duplicative of step 74, it is preferable to repeat the content provider credit check at this point to ensure that the content provider's account balance has not been reduced to an inadequate amount during the course of the transaction. Those of ordinary skill in the art will appreciate that the subsequent content provider credit check in step 156 is optional.

Transaction processor 4 also ensures that the user is allowed to receive this compensation offer (step 158). For example, a check is made against the frequency information for the particular compensation offer to ensure that the offer is still open for acceptance and that the user has not received compensation for this offer in the past or within the time frame established for the offer as stored in compensation data structure 48. If the user is allowed to receive the offer, transaction processor 4 determines if the user has performed the required number of interactions (N) at step 159. If yes, compensation transfer process 42 is initiated and the compensation unit balance is transferred from content provider account 38 associated with content provider processor 8 to the user's account, user account 40 (step 160). The user is notified, preferably through a display screen window, that the balance has been transferred. It should be noted that although steps 150, 152, 156 and 158 are listed sequentially, it is contemplated that these steps need not occur in any particular order. The session key can be extended at each stage, a stage being defined as any interaction between user terminal 6 and transaction processor 4. For example, steps 82, 154 and 160 may involve the transfer of data between user terminals 6 and transaction processor 4 such that at each point in the session, the stage data is added to the session ID key so that transaction processor 4 and user terminals 6 (via the compensation client) are synchronized with respect to exactly which portion of the transaction is current.

As discussed above, when a user is not recognized in step 152, the reasons for this failure may be that the user does not have an account or that the user entered an invalid electronic mail address. In either case, transaction processor 4 sends a notification which is displayed on user terminal 6 informing the user of the failure to recognize the entered electronic mail (user ID) address. FIG. 10 shows an example of address recognition failure box 90. Address recognition failure box 90 is preferably displayed on user terminal 6 when an electronic mail address authentication is not recognized by transaction processor 4. In this case, the user is invited to reenter their electronic mail address in electronic mail address entry area 92 or to enter their electronic mail address in account creation entry area 94 to create a new account. The user completes the desired field and upon depressing the enter key or selecting an appropriate area on address recognition failure box 90 (not shown), causes user terminal 6 to transmit to transaction processor 4, the electronic mail address along with an indication as to whether the transmission is a re-submission or new account address.

As with any network-based system in which a user is sending or receiving something of perceived value, for example, compensation units, security is a concern. The present invention avoids the use of complicated encrypted data objects and instead concerns itself with the validation and authorization of requests for transactions from content providers and users.

As discussed above, in order for user account 40 to be credited in the amount of earned compensation units, a number of items are preferably evaluated. First, the transaction must be a valid transaction. Second, the web site display page must be one in which the transaction is authorized to take place, as defined by the content provider. Third, the web page must have been accessed in the manner intended by the content provider. Fourth, the user must be able to make a proper identification to transaction server 4.

In order to achieve these objectives, the present invention provides a number of security features. First, transaction processor 4 makes checks at several points, as discussed above, to authenticate the request for a compensation unit transaction. The first check is made prior to sending web site display page 32. This feature, referred to as “silent check-in,” is discussed below in detail and authenticates the availability of a domain level cookie at particular web site display page 32. The second check point is embedded within web site display page 32 prior to the transmission of the compensation client from transaction processor 4 to user terminal 6. This is accomplished by using an image tag and a unique ID for the session.

A third authentication check is made prior to completion of the transaction as part of step 150.

The silent check-in feature of the present invention is now described. Initially, it should be noted that although the silent check-in feature is preferred, it is not necessary for the operation of the invention. Silent check-in is accomplished such that transaction processor 4 places a unique session cookie on the user terminal 6 at the time the user initially seeks to enter the web site and load a web site display page other than the page in which the compensation offers are placed. The session cookie is comprised of a unique session identifier, the time of cookie placement and an indication of the URL of the entering web site display page.

The silent check-in cookie session value is a key unique to user terminal 6 set upon entry of the content provider web site, at that terminal, at that time. This key expires when the user leaves the content providers' web site. When a user displays web site display page 32 containing a compensation unit offer, for example, compensation information area 64, transaction processor 4 checks for the presence of a valid check-in cookie before issuing the compensation client. A user who attempts to bypass this silent check-in by manually creating a cookie on their user terminal will fail since the cookie value is unique to one user session.

The silent check-in feature can be arranged to accommodate more than one web site check-in point by creating multiple records in sessions data structure 54. As such, the silent check-in feature provides an additional level of security beyond merely tracking a user's prior compensation offer acceptance and URL origination point for offer acceptance.

Prior to the transmission of the compensation client, transaction processor 4 scans the silent check-in cookie to ensure that the user entered the content provider's web site at the designated location, and within a designated period of time. This ensures that the user has entered the content provider's web site at the designated location.

Another advantageous aspect of the present invention allows for the compilation and implementation of trails in which a user receives additional compensation units for engaging in a series of content provider mandated steps when progressing through the content provider's site.

Trails allow a user to be compensated for an individual pattern of consumer behavior by encouraging users to engage in a series of steps during their visit to the content provider's site. A trail is preferably arranged into a number of portions. Each portion preferably awards compensation units according to prior behavior, for example, that the user has visited the content provider's home page in this visit and/or that the user has taken up a previous trail portion. Different amounts of compensation units can be awarded at each trail portion.

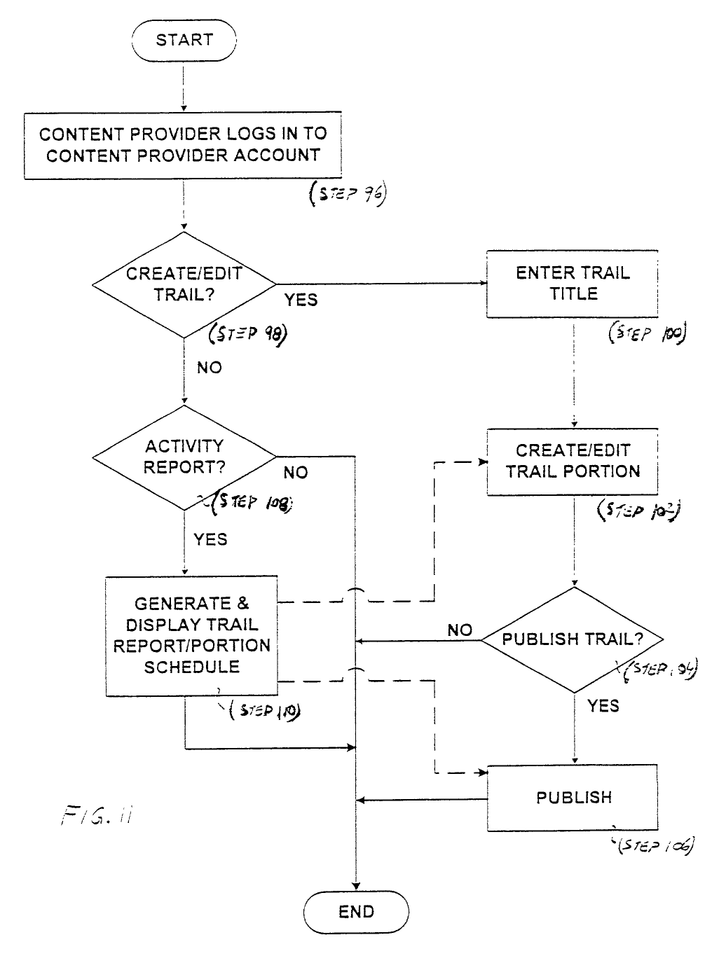

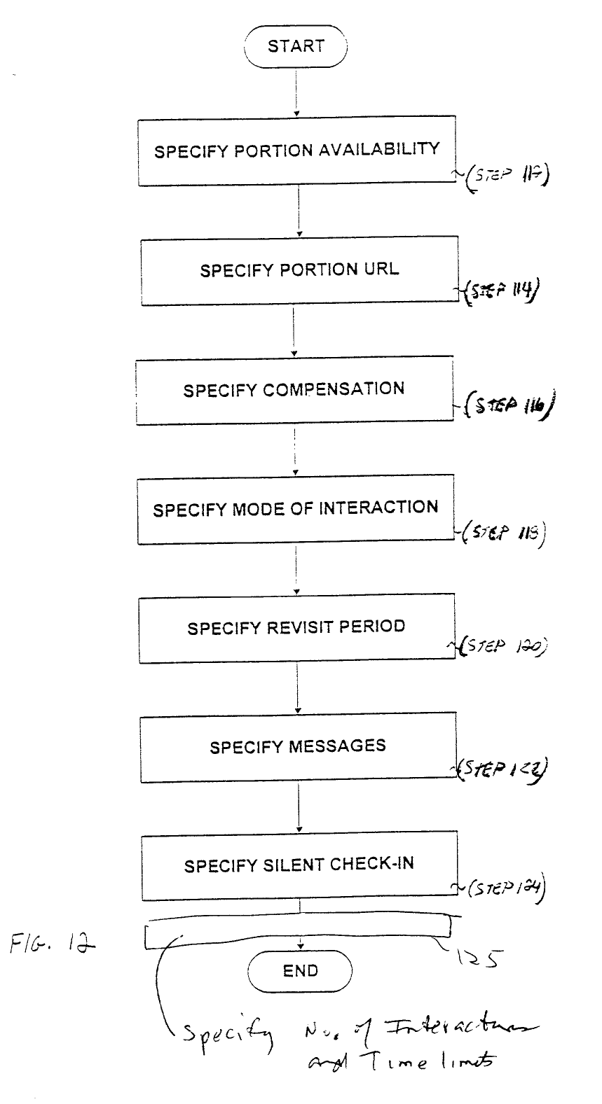

Trail processes are explained with reference to FIGS. 11 and 12. FIG. 11 is a flow chart of the overall trail processes from the content provider's perspective for the present invention. There may be no explicitly defined steps in the trail, it may just be an area of content which can be accessed at the users' discretion. Initially, a content provider who seeks to create or edit a trail or receive activity reports relating to established trails logs into their account on transaction server 4 from content provider processor 8 or any other terminal which can access transaction processor 4 via communication network 16, and which is preferably equipped with web browser software such as that described above with respect to user terminal 6 (step 96). As such, although trail creation and editing processes are described in terms of accessing transaction processor 4 via content provider processor 8, the invention is not so limited.

The trail process is preferably comprised of two main aspects, namely, the creation and editing of trails, and the generation of activity reports. Once logged in, the content provider user is presented with these two options on their display. Selection is preferably made by selecting an appropriate link.

In the case where a user wishes to create or edit a trail (step 98), transaction processor 4 requests that the user enter the title of the trail, which is subsequently entered by the content provider user and transmitted to transaction processor 4 (step 100). The content provider user is then taken through a step-by-step process in which they create or edit a trail portion (step 102). Step 102 is explained in detail below. The content provider user can continue to create or edit trail portions until they are completed at which time they are provided with the option to publish their trail (step 104).

Publishing the trail causes transaction processor 4 to generate the appropriate software code, for example, HTML code, needed by the content provider to support the web site on content provider processor 8. When a content provider user indicates their desire to publish the trail, transaction processor 4 causes the necessary programmatic code to be displayed on the content provider user's terminal display in textual form. The user can then incorporate this code into their own site by simply cutting and pasting the displayed text into their own web site code.

In the case where the user does not wish to publish the trail, the trail data is stored on database 10 for future editing and publishing.

In the case where a content provider user wishes to prepare an activity report (step 108), the user is preferably presented with a choice of preparing a trail report or a portion schedule.

Upon selection, transaction processor 4 generates the selected report or schedule and sends it to the content provider user terminal for viewing (step 110).

The trail report offers a quick snapshot of activity across a whole trail and the portion schedule enables the content provider user to quickly determine scheduling for each portion and preferably provides a link which, when selected, directly allows a user to edit a trail portion such as that in step 102.

Trail reports preferably show the total number of compensation units given, the quantity of users to which those compensation units have been given, and how many transactions have been executed across the entirety of the trail. The report additionally preferably provides a portion-by-portion breakdown for each of the totals described above along with an option which allows a time period-by-time period review of this information, for example, daily for seven days, etc.

The portion schedule shows basic trail portion information, including the portion number, opening message presented on user terminal 6, the quantity of compensation units provided for that trail portion, the URL of the trail portion, a target for the finishing message, along with any requirements to visit previous portions before compensation units for that particular portion will be transferred to user account 40.

The trail schedule preferably allows a content provider user to quickly edit a stage, create a new stage or publish the trail as described with respect to steps 102 and 106.

The trail portion creation and editing processes are described with respect to FIG. 12 which is a detailed flow chart of step 102. After entering the trail title in step 100, user terminal 6 displays a series of availability options from which the user must specify (step 112). Portion availability is available for all portions other than the first portion. It allows the content provider user to require that this portion is only made available to a user who has completed the previous portion. If a revisit period is set on the previous portion, for example, once a day, then this portion must also be visited during that revisit period. Of course, availability can be established such that the trail portion is available regardless of whether a previous stage has been completed.

The content provider user is then prompted to specify a URL for the portion (step 114). In particular, the content provider user is prompted to specify the exact URL where this portion is to reside. Preferably, for security reasons, the portion will not be displayed if transaction processor 4 detects that it is an invalid page, as for example, where the content provider user enters a typographical error or a URL for a different content provider's site.

The content provider user is prompted to specify the amount of compensation which will be provided to users who complete the portion (step 116).

The user is also prompted to specify a mode of interaction between user terminal 6 and the content provider's web site (step 118). Modes of interaction preferably include button or automatic pop-up modes. Selecting the button mode of interaction option provides a display button on user terminal 6, provided by transaction processor 4 as the content provider's web page is loading on user terminal 6. The button is preferably 70 pixels across and 50 pixels high and preferably includes a scrolling message with the content provider's name and amount of compensation available if it is selected.

The automatic pop-up mode of interaction causes an applet or the file to be transmitted to user terminal 6 from transaction processor 4 which then appears on the display of user terminal 6. The applet is preferably a JAVA applet. In addition, the content provider user can set a delay from the time the content provider page loads to the time the applet appears. Under this option, there is no visible HTML, images or text written to the content provider web page by transaction processor 4. The content provider user also specifies a revisit period (step 120). The revisit period determines how often each user can visit and receive compensation for the portion.

The content provider user can also specify before and after messages. Before and after messages are textual messages which are displayed before the compensation is taken by the user and after the compensation is taken by the user, respectively. Preferably, the after message can be configured so that it is linked to another web site page such that the display on user terminal 6 will be redirected to display the linked URL if the user clicks on the final message. Preferably, this option is implemented using a JAVA link instruction. As such, any cookies set on user terminal 6 will persist.

The content provider user can also specify whether or not silent check-in is to be implemented for this trail portion (step 124). Each of the displays generated on the content provider user's display for steps 112-124 can be implemented using known HTML or other graphical user interface coding methods as along as the particular specification requested is clear and a facility is provided for the specification, for example, radio buttons, pull-down menus, textual entry areas, etc.

Data corresponding to each of the content provider user's selections for the created or edited portion is generated by the content provider user's terminal and transmitted to transaction processor 4. Transaction processor 4 updates database 10 data structures as necessary to reflect the created or edited trail portion, for example, the offers data structure ,etc.

Step 125 allows the content provider to determine if a plurality of interactions will be necessary to earn compensation units. For example, the content provider may require that the user visit the content provider's web site on a plurality of occasions, or that a defined number of activities occur at the content provider's website or that a certain amount of time be spent at the website. In such case, the user will accumulate credits or events but will not obtain compensation until the defined number of credits or events or defined credit level has been reached. Further, the content provider may also set a minimum elapsed time between interactions (to deter fraud) and/or a maximum time between any two (not necessarily consecutive) interactions.

Another aspect of the present invention preferably allows a user to redeem compensation units in the manner discussed above. FIG. 13 shows an example of redemption display screen 126 presented on the display of user terminal 6 by content provider processor 8. Redemption display screen 126 is preferably comprised of redemption banner 128, content provider material 130, item descriptions 132 and corresponding item costs 134.

Redemption banner 128 is any message deemed appropriate by the content provider. Content provider material 130 can be any material deemed appropriate by the content provider, for example, an advertisement related to one of the items offered for sale, links to other display screens, and the like. Item descriptions 132 are preferably arranged in a columnar fashion as are corresponding item costs 134 such that each row represents an item description and corresponding cost. Of course, item descriptions and costs can be arranged in any manner deemed appropriate by the designer of redemption display screen 126.

Preferably, an item description 132 provides a summary description which, if selected by the user, causes a more detailed display screen to appear on user terminal 6 which provides detailed information about the selected item. Also, redemption display screen 126 is preferably arranged so that selecting item cost 134 initiates a process by which the item is selected for redemption at its corresponding compensation unit cost, thereby initiating compensation transfer process 42 to debit user account 40 and credit content provider account 38. Purchased items are then shipped to the user using any known shipment method.

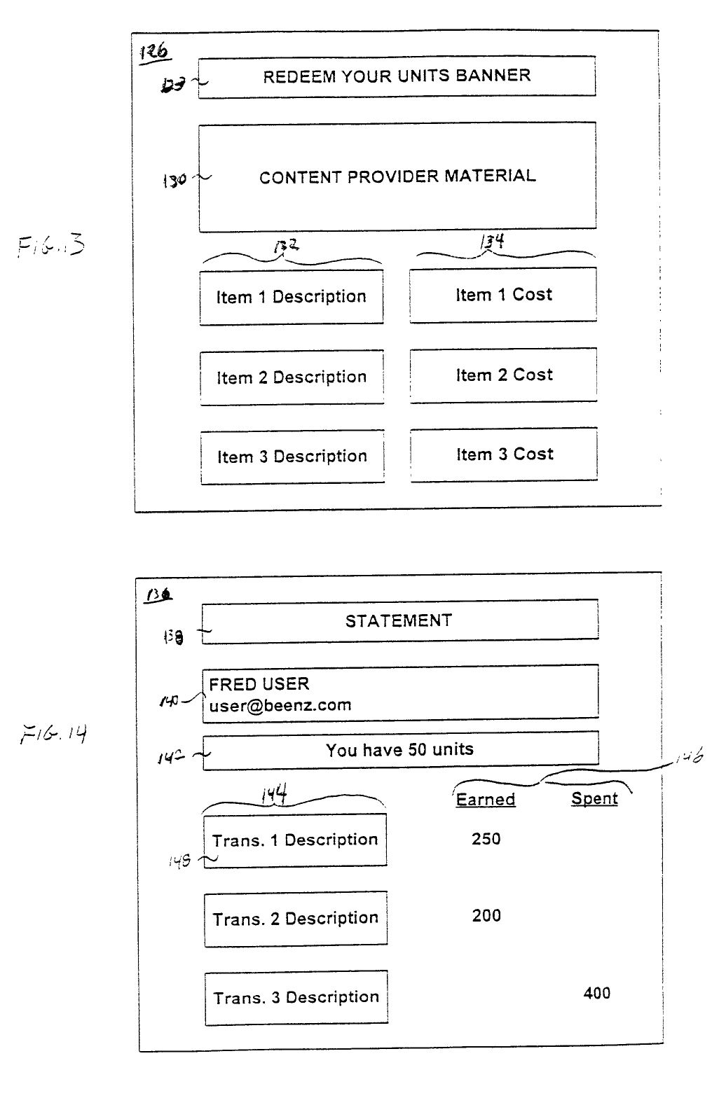

Another aspect of the invention allows a user to quickly review the details of their corresponding user account 40. FIG. 14 is an example of statement display screen 136, displayed on user terminal 6 in accordance with data transmitted by transaction processor 4.

Statement display screen 136 is preferably displayed only after the user has entered their electronic mail address and password corresponding to their user account 40. Statement display screen 136 is preferably comprised of title 138, account ownership information area 140, account balance area 142, transaction descriptions 144 and transaction amount area 146. Statement display screen 136 is preferably prepared in accordance with data stored in transactions data structure 52 and account holders data structure 40.

Account owner information area shows the name and electronic mail address (user ID) associated with user account 40. Account balance area 142 shows the current user's account balance. Transaction descriptions preferably provide a summary of the transaction for which the corresponding transaction amount is shown in transaction amount area 146. For example, as shown in FIG. 14, transaction one resulted in earned compensation of 250 compensation units to Fred User.

FIG. 15 shows the details of a transaction description in transaction description 144. For transaction one description box 148. As shown in FIG. 15, transaction one description area 148 shows the date of the transaction, the transaction receipt code and the name of the entity with which the user conducted the transaction.

As such, statement display screen 136 allows a user to quickly view the details of their account.

The present invention advantageously provides a network-based mechanism by which a user can: (1) be compensated for taking action with respect to a content provider's site, (2) redeem those compensation units for products and services, and (3) view the details of their compensation unit accounts.

In addition, the present invention advantageously allows a mechanism by which content providers can be assured that the provider of transaction processor 4 and database 10 will prevent users with fraudulent intent from improperly transferring compensation units to those undeserving users. The present invention also advantageously provides a mechanism by which content providers can create multi-portion trails to encourage users to undertake a series of steps during the user's visit to the content provider's site. Differing amounts of compensation units can be provided for each trail portion.

In addition, the present invention does not require that a user of user terminal 6 contact transaction processor 4 as a portal. The user can proceed directly to content provider processor 8 in order to engage in a compensation earning or redemption transaction. As such, users' actions are not tracked for the purpose of targeting advertisements and users need not provide system 2 with detailed personal profile data.

Although the present invention has been described in relation to particular embodiments thereof, many other variations and modifications and other uses will become apparent to those skilled in the art. It is preferred, therefore, that the present invention be limited not by the specific disclosure herein, but only by the appended claims.

What is claimed is:

1. A method using a communication network to compensate at least one user in exchange for work undertaken by the at least one user, the method comprising the steps of:
using the communication network to perform work, the work being defined by a content provider in a manner which does not target specific user profiles, the work further being defined by a plurality of interactions between the user and the content provider;
making an offer of compensation units to the at least one user in exchange for the performed work whereby the compensation is to be provided after a defined number of the interactions between the user and the content provider;
accepting the offered compensation units; and
storing data related to the number of interactions between the user and the content provider;
transferring the accepted compensation units from a content provider account to a user account after the defined number of interactions has been reached, the content provider account corresponding to the content provider offering the compensation units and the user account corresponding to the user who completed the work.

2. The method according to claim 1, wherein the work is defined as a trail, the trail including a plurality of portions, compensation units being offered by the content provider for each portion.

3. The method according to claim 2, wherein the compensation unit amounts offered by the content provider are not the same for each portion.

4. The method according to claim 2, further comprising the step of publishing a trail, the publishing step including the steps of:
creating programmatic code needed by the content provider to support a web site on a content provider processor associated with the content provider; and
displaying the created programmatic code.

5. The method according to claim 2, wherein each portion is created by the steps of specifying:
to whom the portion is to be made available;
a URL for the portion or domain in which the portion will be made available;
the compensation unit amount for the portion;
a mode of interaction between the at least one user and the content provider processor associated with the content provider;
a period establishing the frequency with which the at least one user can receive compensation units for the portion;
textual messages to be presented to the at least one unit at least one of before or after the compensation units are transferred to the user account; and
the inclusion of a silent check-in option for the portion.

6. The method according to claim 1, wherein the transferring step is completed upon a successful evaluation of the accepted offer.

7. The method according to claim 6, wherein the successful evaluation includes at least one of:
verifying that the at least one user's session is valid;
recognizing the at least one user as a valid user;
determining that the content provider has sufficient credit to compensate the accepting user; and
verifying that the at least one user is approved to accept the offer.

8. The method according to claim 1, further comprising the step of transmitting a client to a user terminal corresponding to the at least one user, the client being used to accept the offer.

9. The method according to claim 8, wherein the step of transmitting the client is executed upon at least one of:
verifying that an offer ID associated with the offered compensation units is valid;
determining that an ID corresponding to the at least one user is valid and is not on hold;
determining that the offer location is correct, a correct offer location being a web site URL from which the at least one user accepted the offer which matches a predetermined URL; and
determining that the content provider has sufficient credit to compensate the accepting user.

10. The method according to claim 8, wherein a cookie is checked to ensure that the user entered a web site associated with the offering content provider and within a predetermined period of time of accepting the offer prior to transmitting the client.

11. The method according to claim 1, wherein the interactions comprise any of:
visits to the content provider's website;
actions taken by the user at the content provider's website; and
a predefined number of time period increments spent at the content provider's website.

12. The method according to claim 11, further comprising recording each interaction in a storage medium as the interaction takes place and transferring the accepted compensation units after the defined number of interactions have occurred.

13. The method according to claim 12, further comprising assigning a code to each web page of the content provider's web site and recording the code in the storage medium when an interaction occurs.

14. The method according to claim 1, wherein at least one of (1) a defined minimum elapsed time must exist between interactions; and (2) a defined maximum time between two interactions must not occur in order to transfer the accepted compensation units.

15. The method according to claim 14, wherein the two interactions against which the defined maximum time is measured need not be consecutive interactions.

16. A transaction processor coupled to a communication network, the transaction processor compensating at least one user in exchange for work undertaken by the at least one user, the transaction processor comprising:
a database, the database comprising:
an account holder data structure having at least one account holder record; and
a content provider data structure having at least one content provider record; and
a central processing unit, the central processing being coupled to the database and executing the functions of:
evaluating a request from a user terminal to transmit a client to the user terminal;
transmitting the client to the user terminal in accordance with a positive evaluation, the client enabling the user terminal to request compensation in the form of compensation units for work performed by a user of the user terminal, the work further being defined by a plurality of interactions between the user and the content provider;
storing data related to the number of interactions between the user and the content provider;
processing a request received from the user terminal to credit an account holder record corresponding to the user of the user terminal with compensation units in accordance with work performed by the user; and
executing a first transaction process which accesses the database and transfers the compensation units from a content provider record corresponding to the offering content provider to the account holder record corresponding to the user if the defined number of interactions has been reached.

17. The transaction processor according to claim 16, wherein the at least one account holder record includes fields comprising:
an account holder ID;
demographic information;
an account holder country;
an account holder language;
personal information corresponding to the account holder; and
a compensation unit balance.

18. The transaction processor according to claim 16, wherein the at least one content provider record includes fields comprising:
a content provider ID;
details corresponding to the content provider's business;
a compensation unit balance; and
a URL corresponding to a home page associated with the content provider.

19. The transaction processor according to claim 16, wherein the database further comprises at least one of:
a compensation data structure, the compensation data structure defining ways in which the at least one user may earn compensation units;
a redemptions data structure, the redemptions data structure defining the ways in which earned compensation units may be spent;
a transactions data structure, the transactions data structure including records relating to accepted offers and redemption of compensation units; and
a sessions data structure, the sessions data structure including records relating to particular transaction sessions in progress.

20. The transaction processor according to claim 19, wherein the compensation data structure includes:
an offer ID;
a value of compensation units corresponding to the offer;
a location at which the offer is made;
dependencies upon which the offer is to be made; and
a mode of operation, the mode of operation defining display parameters corresponding to how the offer is made.

21. The transaction processor according to claim 19, wherein the redemptions data structure includes:
a redemption ID corresponding to an item offered for sale;
a compensation unit price corresponding to the item;
a frequency with which the at least one user can redeem compensation units for the item;
a location at which a redemption offer corresponding to the item is made; and
a mode of operation, the mode of operation defining display parameters corresponding to how the redemption offer is made.

22. The transaction processor according to claim 16, wherein the work is defined as a trail, the trail including a plurality of portions, compensation units being offered by the content provider for each portion.

23. The transaction processor according the claim 22, wherein each portion includes data identifying:
to whom the portion is to be made available;
a URL for the portion or domain in which the portion will be made available;
the compensation unit amount for the portion;
a mode of interaction between the at least one user and the content provider processor associated with the content provider;
a period establishing the frequency with which the at least one user can receive compensation units for the portion;
textual messages to be presented to the at least one unit at least one of before or after the compensation units are transferred to the user account; and
the inclusion of a silent check-in option for the portion.

24. The transaction processor according to claim 16, wherein the positive evaluation includes at least one of:
verifying that an offer ID associated with the offered compensation units is valid;
determining that an ID corresponding to the at least one user is valid and is not on hold;
determining that the offer location is correct, a correct offer location being a web site URL from which the at least one user accepted the offer which matches a predetermined URL; and
determining that the content provider has sufficient credit to compensate the accepting user.

25. The transaction processor according to claim 16, wherein a cookie is checked to ensure that the at least one user entered a web site associated with an offering content provider and within a predetermined period of time of accepting the offer prior to transmitting the client.

26. The transaction processor according to claim 16, wherein the interactions comprise any of:
visits to the content provider's website;
actions taken by the user at the content provider's website; and
a predefined number of time period increments spent at the content provider's website.

27. The transaction processor according to claim 21, further comprising recording each interaction in a storage medium as the interaction takes place and transferring the accepted compensation units after the defined number of interactions have occurred.

28. The transaction processor according to claim 27, further comprising assigning a code to each web page of the content provider's web site and recording the code in the storage medium when an interaction occurs.

29. The transaction processor according to claim 16, wherein at least one of (1) a defined minimum elapsed time must exist between interactions; and (2) a defined maximum time between two interactions must not occur in order to transfer the accepted compensation units.

30. The transaction processor according to claim 29, wherein the two interactions against which the defined maximum time is measured need not be consecutive interactions.

31. A system employing a communication network to compensate at least one user in exchange for work undertaken by the at least one user, the work being offered by an offering content provider, the system comprising:
at least one user terminal;
at least one content provider processor coupled to the at least one user terminal through a communication network;
at least one transaction processor coupled to the at least one user terminal and the at least one content provider processor through the communication network;
the at least one transaction processor:
receiving a request from the at least one user terminal to transmit a client to the at least one user terminal;
transmitting the client to the at least one user terminal in accordance with a positive evaluation, the client enabling the at least one user terminal to request compensation for work performed by a user of the at least one user terminal, the work further being defined by a plurality of interactions between the user and the content provider;
storing data related to the number of interactions between the user and the content provider;
processing a request received from the user terminal to credit a user account corresponding to the user of the user terminal with compensation in accordance with work performed by the user; and
transferring the compensation from a content provider account corresponding to the offering content provider to the user account if the defined number of interactions has been reached.

32. The system according to claim 31, further comprising a selling content provider processor, the selling content provider processor offering items to the at least one user in exchange for the redemption of compensation units.

33. The system according to claim 31, wherein the work is defined as a trail, the trail including a plurality of portions, compensation units being offered by the content provider for each portion.

34. The system according to claim 33, wherein the at least one transaction processor creates programmatic code needed by the offering content provider to support a web site on the offering content provider processor.

35. The system according to claim 33, wherein each portion includes data identifying:
to whom the portion is to be made available;
a URL for the portion or domain in which the portion will be made available;
the compensation unit amount for the portion;
a mode of interaction between the at least one user and the offering content provider processor associated with the offering content provider;
a period establishing the frequency with which the at least one user can receive compensation units for the portion;
textual messages to be presented to the at least one unit at least one of before or after the compensation units are transferred to the user account; and
the inclusion of a silent check-in option for the portion.

36. The system according to claim 31, wherein the positive evaluation includes:
verifying that an offer ID associated with the offered compensation units is valid;
determining that an ID corresponding to the at least one user is valid and is not on hold;
determining that the offer location is correct, a correct offer location being a web site URL from which the at least one user accepted the offer which matches a predetermined URL; and
determining that the content provider has sufficient credit to compensate the accepting user.

37. The system according to claim 31, wherein a cookie is checked to ensure that the at least one user entered a web site associated with the offering content provider and within a predetermined period of time of accepting the offer prior to transmitting the client.

38. The system according to claim 31, wherein the interactions comprise any of:
visits to the content provider's website;
actions taken by the user at the content provider's website; and
a predefined number of time period increments spent at the content provider's website.

39. The systems according to claim 31, further comprising recording each interaction in a storage medium as the interaction takes place and transferring the accepted compensation units after the defined number of interactions have occurred.

40. The system according to claim 39, further comprising assigning a code to each web page of the content provider's web site and recording the code in the storage medium when an interaction occurs.

41. The system according to claim 31, wherein at least one of (1) a defined minimum elapsed time must exist between interactions; and (2) a defined maximum time between two interactions must not occur in order to transfer the accepted compensation units.

42. The system according to claim 41, wherein the two interactions against which the defined maximum time is measured need not be consecutive interactions.

43. A method for using a communication network to facilitate transactions in which compensation units are earned and spent by at least one user, the method comprising the steps of:
using the communication network to perform work, the work being defined by a content provider in a manner which does not target specific user profiles, the work further being defined by a plurality of interactions between the user and the content provider;
making an offer of compensation units to the at least one user in exchange for the performed work whereby the compensation is to be provided after a defined number of the interactions;
accepting the offered compensation units;
storing data related to the number of interactions between the user and the content provider;
transferring the accepted compensation units from a content provider account to a user account if the defined number of interactions has been reached, the content provider account corresponding to the content provider offering the compensation units and the user account corresponding to the user who completed the work; and
transferring compensation units from the user account to a spending content provider account in an amount corresponding to a cost of a purchase made by the user.

44. The method according to claim 43, wherein the work is defined as a trail, the trail including a plurality of portions, compensation units being offered by the content provider for each portion.

45. The method according to claim 44, wherein the compensation unit amounts offered by the content provider are not the same for each portion.

46. The method according to claim 44, further comprising the step of publishing a trail, the publishing step including the steps of:
creating programmatic code needed by the content provider to support a web site on a content provider processor associated with the content provider; and
displaying the created programmatic code.

47. The method according the claim 44, wherein each portion is created by the steps of specifying:
to whom the portion is to be made available;
a URL for the portion or domain in which the portion will be made available;
the compensation unit amount for the portion;
a mode of interaction between the at least one user and the content provider processor associated with the content provider;
a period establishing the frequency with which the at least one user can receive compensation units for the portion;
textual messages to be presented to the at least one unit at least one of before or after the compensation units are transferred to the user account; and
the inclusion of a silent check-in option for the portion.

48. The method according to claim 43, wherein the transferring step is completed upon a successful evaluation of the accepted offer.

49. The method according to claim 48, wherein the successful evaluation includes at least one of:
verifying that the at least one user's session is valid;
recognizing the at least one user as a valid user;
determining that the content provider has sufficient credit to compensate the accepting user; and
verifying that the at least one user is approved to accept the offer.

50. The method according to claim 43, further comprising the step of transmitting a client to a user terminal corresponding to the at least one user, the client being used to accept the offer.

51. The method according to claim 50, wherein the step of transmitting the client is executed upon at least one of:
verifying that an offer ID associated with the offered compensation units is valid;
determining that an ID corresponding to the at least one user is valid and is not on hold;
determining that the offer location is correct, a correct offer location being a web site URL from which the at least one user accepted the offer which matches a predetermined URL; and
determining that the content provider has sufficient credit to compensate the accepting user.

52. The method according to claim 50, wherein a cookie is checked to ensure that the user entered a web site associated with the offering content provider and within a predetermined period of time of accepting the offer prior to transmitting the client.

53. The method according to claim 43, wherein the interactions comprise any of:
visits to the content provider's website;
actions taken by the user at the content provider's website; and
a predefined number of time period increments spent at the content provider's website.

54. The method according to claim 53, further comprising recording each interaction in a storage medium as the interaction takes place and transferring the accepted compensation units after the defined number of interactions have occurred.

55. The method according to claim 54, further comprising assigning a code to each web page of the content provider's web site and recording the code in the storage medium when an interaction occurs.

56. The method according to claim 43, wherein at least one of (1) a defined minimum elapsed time must exist between interactions; and (2) a defined maximum time between interactions must not occur in order to transfer the accepted compensation units.

57. The method according to claim 56, wherein the two interactions against which the defined maximum time is measured need not be consecutive interactions.

58. A transaction processor coupled to a communication network, the transaction processor facilitating transactions in which compensation units are earned and spent by at least one user, the transaction processor comprising:
a database, the database comprising:
an account holder data structure having at least one account holder record; and
a content provider data structure having at least one content provider record; and
a central processing unit, the central processing being coupled to the database and executing the functions of:
evaluating a request from a user terminal to transmit a client to the user terminal;
transmitting the client to the user terminal in accordance with a positive evaluation, the client enabling the user terminal to request compensation in the form of compensation units for work performed by a user of the user terminal, the work further being defined by a plurality of interactions between the user and the content provider;
storing data related to the number of interactions between the user and the content provider;
processing a request received from the user terminal to credit an account holder record corresponding to the user of the user terminal with compensation units in accordance with work performed by the user;
executing a first transaction process which accesses the database and transfers the compensation units from a content provider record corresponding to the offering content provider to the account holder record corresponding to the user if the defined number of interactions has been reached; and
executing a second transaction process which accesses the database and transfers compensation units in an amount of a purchase made by the user from the corresponding user account holder record to a content provider record corresponding to the content provider from whom the purchase was made.

59. The transaction processor according to claim 58, wherein the at least one account holder record includes fields comprising:
an account holder ID;
demographic information;
an account holder country;
an account holder language;
personal information corresponding the account holder; and
a compensation unit balance.

60. The transaction processor according to claim 58, wherein the database further comprises at least one of:
a compensation data structure, the compensation data structure defining ways in which the at least one user may earn compensation units;
a redemptions data structure, the redemptions data structure defining the ways in which earned compensation units may be spent;
a transactions data structure, the transactions data structure including records relating to accepted offers and redemption of compensation units; and
a sessions data structure, the sessions data structure including records relating to particular transaction sessions in progress.

61. The transaction processor according to claim 60, wherein the compensation data structure includes:
an offer ID;
a value of compensation units corresponding to the offer;
a location at which the offer is made;
dependencies upon which the offer is to be made; and
a mode of operation, the mode of operation defining display parameters corresponding to how the offer is made.

62. The transaction processor according to claim 60, wherein the redemptions data structure includes:
a redemption ID corresponding to an item offered for sale;
a compensation unit price corresponding to the item;
a frequency with which the at least one user can redeem compensation units for the item;
a location at which a redemption offer corresponding to the item is made; and
a mode of operation, the mode of operation defining display parameters corresponding to how the redemption offer is made.

63. The transaction processor according to claim 58, wherein the work is defined as a trail, the trail including a plurality of portions, compensation units being offered by the content provider for each portion.

64. The transaction processor according to claim 63, wherein each a portion includes data identifying:
to whom the portion is to be made available;
a URL for the portion or domain in which the portion will be made available;
the compensation unit amount for the portion;
a mode of interaction between the at least one user and the content provider processor associated with the content provider;
a period establishing the frequency with which the at least one user can receive compensation units for the portion;
textual messages to be presented to the at least one unit at least one of before or after the compensation units are transferred to the user account; and
the inclusion of a silent check-in option for the portion.

65. The transaction processor according to claim 58, wherein the positive evaluation includes at least one of:
verifying that an offer ID associated with the offered compensation units is valid;
determining that an ID corresponding to the at least one user is valid and is not on hold;
determining that the offer location is correct, a correct offer location being a web site URL from which the at least one user accepted the offer which matches a predetermined URL; and
determining that the content provider has sufficient credit to compensate the accepting user.

66. The transaction processor according to claim 58, wherein a cookie is checked to ensure that the at least one user entered a web site associated with an offering content provider and within a predetermined period of time of accepting the offer prior to transmitting the client.

67. The transaction process according to claim 58, wherein the interactions comprising any of:
visits to the content provider's website;
actions taken by the user at the content provider's website; and
a predefined number of time period increments spent at the content provider's website.

68. The transaction process according to claim 67, further comprising recording each interaction in a storage medium as the interaction takes place and transferring the accepted compensation units after the defined number of interactions have occurred.

69. The transaction process according to claim 68, further comprising assigning a code to each web page of the content provider's web site and recording the code in the storage medium when an interaction occurs.

70. The transaction process according to claim 58, wherein at least one of (1) a defined minimum elapsed time must exist between interactions; and (2) a defined maximum time between two interactions must not occur in order to transfer the accepted compensation units.

71. The transaction process according to claim 70, wherein the two interactions against which the defined maximum time is measured need not be consecutive interactions.

72. A system for facilitating transactions in which compensation units are earned and spent by at least one user, the system comprising:
at least one user terminal;
at least one content provider processor coupled to the at least one user terminal through a communication network;
at least one transaction processor coupled to the at least one user terminal and the at least one content provider processor through the communication network;
the at least one transaction processor:
receiving a request from the at least one user terminal to transmit a client to the at least one user terminal;
transmitting the client to the at least one user terminal in accordance with a positive evaluation, the client enabling the at least one user terminal to request compensation for work performed by a user of the at least one user terminal, the work further being defined by a plurality of interactions between the user and the content provider;
storing data related to the number of interactions between the user and the content provider;
processing a request received from the user terminal to credit a user account corresponding to the user of the user terminal with compensation units in accordance with work performed by the user;
transferring the compensation units from a content provider account corresponding to the offering content provider to the user account if the defined number of interactions has been reached; and
transferring compensation units in an amount of a purchase made by the user from the corresponding user account to a content provider account from whom the purchase was made.

73. The system according to claim 72, wherein the work is defined as a trail, the trail including a plurality of portions, compensation units being offered by the content provider for each portion.

74. The system according to claim 73, wherein the at least one content provider processor is an offering content provider processor and the at least one transaction processor creates programmatic code needed to support a web site on the offering content provider processor.

75. The system according the claim 73, wherein each portion includes data identifying:
to whom the portion is to be made available;
a URL for the portion or domain in which the portion will be made available;
the compensation unit amount for the portion;
a mode of interaction between the at least one user and the content provider processor associated with the content provider;
a period establishing the frequency with which the at least one user can receive compensation units for the portion;
textual messages to be presented to the at least one unit at least one of before or after the compensation units are transferred to the user account; and
the inclusion of a silent check-in option for the portion.

76. The system according to claim 72, wherein the positive evaluation includes:
verifying that an offer ID associated with the offered compensation units is valid;
determining that an ID corresponding to the at least one user is valid and is not on hold;
determining that the offer location is correct, a correct offer location being a web site URL from which the at least one user accepted the offer which matches a predetermined URL; and
determining that the content provider has sufficient credit to compensate the accepting user.

77. The system according to claim 72, wherein a cookie is checked to ensure that the at least one user entered a web site associated with the offering content provider and within a predetermined period of time of accepting the offer prior to transmitting the client.

78. The system according to claim 72, wherein the interactions comprising any of:
visits to the content provider's website;
actions taken by the user at the content provider's website; and
a predefined number of time period increments spent at the content provider's website.

79. The system according to claim 78, further comprising recording each interaction in a storage medium as the interaction takes place and transferring the accepted compensation units after the defined number of interactions have occurred.

80. The system according to claim 79, further comprising assigning a code to each web page of the content provider's web site and recording the code in the storage medium when an interaction occurs.

81. The system according to claim 72, wherein at least one of (1) a defined minimum elapsed time must exist between interactions; and (2) a defined maximum time between two interactions must not occur in order to transfer the accepted compensation units.

82. The system according to claim 81, wherein the two interactions against which the defined maximum time is measured need not be consecutive interactions.

83. A computer readable storage medium storing computer executable program code, which when run, executes a method for compensating at least one user in exchange for work undertaken by the at least one user, the method comprising the steps of:
receiving a request from the at least one user terminal to transmit a client to the at least one user terminal;
transmitting the client to the at least one user terminal in accordance with a positive evaluation, the client enabling the at least one user terminal to request compensation for work performed by a user of the at least one user terminal, the work further being defined by a plurality of interactions between the user and the content provider;
storing data related to the number of interactions between the user and the content provider;
processing a request received from the user terminal to credit a user account corresponding to the user of the user terminal with compensation units in accordance with work performed by the user; and
transferring the compensation units from a content provider account corresponding to the offering content provider to the user account if the defined number of interactions has been reached.

84. The computer readable storage medium according to claim 83, wherein the work is defined as a trail, the trail including a plurality of portions, compensation units being offered by the content provider for each portion.

85. The computer readable storage medium according to claim 84, wherein the method further comprises the step of publishing a trail, the publishing step including the steps of:
creating programmatic code needed by the content provider to support a web site on a content provider processor associated with the content provider; and
displaying the created programmatic code.

86. The computer readable storage medium according the claim 84, wherein a portion is created by the steps of specifying:
to whom the portion is to be made available;
a URL for the portion or domain in which the portion will be made available;
the compensation unit amount for the portion;
a mode of interaction between the at least one user and the content provider processor associated with the content provider;
a period establishing the frequency with which the at least one user can receive compensation units for the portion;
textual messages to be presented to the at least one unit at least one of before or after the compensation units are transferred to the user account; and
the inclusion of a silent check-in option for the portion.

87. The computer readable storage medium according to claim 83, wherein the positive evaluation includes at least one of:
verifying that an offer ID associated with the offered compensation units is valid;
determining that an ID corresponding to the at least one user is valid and is not on hold;
determining that the offer location is correct, a correct offer location being a web site URL from which the at least one user accepted the offer which matches a predetermined URL; and
determining that the content provider has sufficient credit to compensate the accepting user.

88. The computer readable storage medium according to claim 83, wherein a cookie is checked to ensure that the user entered a web site associated with the offering content provider and within a predetermined period of time of accepting the offer prior to transmitting the client.

89. The computer readable storage medium according to claim 83, wherein the method further includes the step of transferring an amount of compensation units from the user account to a content provider account corresponding to a selling content provider account in accordance with a purchase made by the at least one user.

90. The computer readable storage medium according to claim 83, wherein the interactions comprising any of:
visits to the content provider's website;
actions taken by the user at the content provider's website; and
a predefined number of time period increments spent at the content provider's website.

91. The computer readable storage medium according to claim 90, further comprising recording each interaction in a storage medium as the interaction takes place and transferring the accepted compensation units after the defined number of interactions have occurred.

92. The computer readable storage medium according to claim 91, further comprising assigning a code to each web page of the content provider's web site and recording the code in the storage medium when an interaction occurs.

93. The computer readable storage medium according to claim 83, wherein at least one of (1) a defined minimum elapsed time must exist between interactions; and (2) a defined maximum time between two interactions must not occur in order to transfer the accepted compensation units.

94. The computer readable storage medium according to claim 93, wherein the two interactions against which the defined maximum time is measured need not be consecutive interactions.
